(19) United States
(12) Patent Application Publication
(10) Pub. No.: US 2012/0300492 A1
(43) Pub. Date: Nov. 29, 2012

(54) Display Device and Backlight Module Thereof

(75) Inventor: Yanxue Zhang, Shenzhen City (CN)

(73) Assignee: Shenzhen China Star Optoelectronics Technology Co., LTD., Shenzhen City, Guangdong (CN)

(21) Appl. No.: 13/375,475

(22) PCT Filed: Jul. 18, 2011
(86) PCT No.: PCT/CN2011/077236

§ 371 Date: Nov. 30, 2011

(30) Foreign Application Priority Data
May 26, 2011 (CN) 201120172560.7

(51) Int. Cl. G09F 13/04; F21V 8/00

(52) U.S. Cl. 362/602; 362/97.1

(57) ABSTRACT

A backlight module and a display device comprising the same are disclosed. The backlight module comprises a light source and a backplate. The backplate comprises an aluminum extruded piece and a plastic baseplate. The plastic baseplate is fixedly connected to a side of the aluminum extruded piece, and the light source is disposed on a sidewall of the aluminum extruded piece that is located at a side away from the plastic baseplate. The backlight module and the display device of the present disclosure have the aluminum extruded piece formed as a part of the backplate of the backlight module and have the light source integrated onto the aluminum extruded piece directly. In this way, heat generated by the light source can be transmitted through the aluminum extruded piece to the atmosphere directly to reduce contact heat resistance, thus improving the heat dissipation efficiency.

### FIELD OF THE INVENTION

The present disclosure generally relates to the technical field of displaying, and more particularly, to a display device and a backlight module thereof.

### BACKGROUND OF THE INVENTION

Backlight modules are known as essential and integral modules of display devices, and LEDs are commonly used in backlight modules as a light source. Because a certain amount of heat is inevitably generated by the LED light source during operation, an aluminum extruded piece is usually adopted for heat dissipation in order to prevent degradation of the service life and the light emission efficiency of the LEDs due to a too high temperature.

Referring to FIG. 1, there is shown a schematic structural view of display device 1 in a prior art. Taking a liquid crystal display (LCD) device as an example, the display device 1 comprises a display panel 10, a plastic part 12, a front frame 14 and a backlight module 16. The display panel 10 is disposed above the backlight module 16, and the front frame 14 and the plastic part 12 cooperate with each other to fix the display panel 10 and the backlight module 16. The backlight module 16 comprises a light guide plate 161, a light source 162, an aluminum extruded piece 163 and a backplate 164. The light source 162 is disposed adjacent to a sidewall of the aluminum extruded piece 163 and also adjacent to a light incident surface of the light guide plate 161. As can be seen, the heat dissipation path for the prior art light source is from the light source 162 to the aluminum extruded piece 163 and further to the backplate 164. A poor heat dissipating effect cause by the poor heat dissipation design and existence of the heat resistance. Furthermore, a large amount of aluminum extruded pieces are required in the prior art backlight module, which increases material cost of the backlight module.

In view of this, an urgent need exists in the art to provide an improved backlight module that can make an improvement on the aforesaid shortcomings of the prior art backlight module.

### SUMMARY OF THE INVENTION

A primary objective of the present disclosure is to provide a display device and a backlight module thereof that can improve the heat dissipation efficiency and reduce the material cost.

To achieve this objective, an embodiment of the present disclosure provides a backlight module, which comprises a light source and a backplate. The backplate comprises an aluminum extruded piece and a plastic baseplate. The plastic baseplate is fixedly connected to a side of the aluminum extruded piece, and the aluminum extruded piece is provided with a hollow portion at a side away from the plastic baseplate. The light source is disposed on a sidewall of the aluminum extruded piece that is located at the side away from the plastic baseplate.

According to a preferred embodiment of the present disclosure, the hollow portion comprises heat-dissipating fins, and both ends of the hollow portion open to the outside.

To achieve the aforesaid objective, another embodiment of the present disclosure provides a backlight module, which comprises a light source and a backplate. The backplate comprises an aluminum extruded piece and a plastic baseplate. The plastic baseplate is fixedly connected to a side of the aluminum extruded piece, and the light source is disposed on a sidewall of the aluminum extruded piece that is located at a side away from the plastic baseplate.

According to a preferred embodiment of the present disclosure, the light source is soldered to the sidewall of the aluminum extruded piece that is located at the side away from the plastic baseplate.

According to a preferred embodiment of the present disclosure, the aluminum extruded piece comprises a first aluminum extruded piece and a second aluminum extruded piece, and the plastic baseplate is disposed between the first aluminum extruded piece and the second aluminum extruded piece.

According to a preferred embodiment of the present disclosure, both the aluminum extruded piece and the plastic baseplate are formed with a plurality of fixing holes, and the aluminum extruded piece is fixedly connected to the plastic baseplate by screws inserted through the plurality of fixing holes.

According to a preferred embodiment of the present disclosure, the aluminum extruded piece is provided with a hollow portion at a side away from the plastic baseplate.

According to a preferred embodiment of the present disclosure, the hollow portion comprises heat-dissipating fins, and both ends of the hollow portion open to the outside.

According to a preferred embodiment of the present disclosure, the hollow portion is disposed on a bottom surface of the aluminum extruded piece that is located at the side away from the plastic baseplate.

According to a preferred embodiment of the present disclosure, the hollow portion is disposed on an outer surface of the sidewall where the light source is disposed and is opposite to the light source.

According to a preferred embodiment of the present disclosure, the backlight module further comprises a light guide plate located above the backplate, and a light incident surface of the light guide plate is disposed to face towards the light source.

To achieve the aforesaid objective, a further embodiment of the present disclosure provides a display device comprising a backlight module. The backlight module comprises a light source and a backplate. The backplate comprises an aluminum extruded piece and a plastic baseplate. The plastic baseplate is fixedly connected to a side of the aluminum extruded piece, and the light source is disposed on a sidewall of the aluminum extruded piece that is located at a side away from the plastic baseplate.

According to a preferred embodiment of the present disclosure, the light source is soldered to the sidewall of the aluminum extruded piece that is located at the side away from the plastic baseplate.

According to a preferred embodiment of the present disclosure, the aluminum extruded piece comprises a first aluminum extruded piece and a second aluminum extruded piece, and the plastic baseplate is disposed between the first aluminum extruded piece and the second aluminum extruded piece.

According to a preferred embodiment of the present disclosure, both the aluminum extruded piece and the plastic baseplate are formed with a plurality of fixing holes, and the aluminum extruded piece is fixedly connected to the plastic baseplate by screws inserted through the plurality of fixing holes.

According to a preferred embodiment of the present disclosure, the aluminum extruded piece is provided with a hollow portion at a side away from the plastic baseplate.

According to a preferred embodiment of the present disclosure, the hollow portion comprises heat-dissipating fins, and both ends of the hollow portion open to the outside.

According to a preferred embodiment of the present disclosure, the hollow portion is disposed on a bottom surface of the aluminum extruded piece that is located at the side away from the plastic baseplate.

According to a preferred embodiment of the present disclosure, the hollow portion is disposed on an outer surface of the sidewall where the light source is disposed and is opposite to the light source.

According to a preferred embodiment of the present disclosure, the backlight module further comprises a light guide plate located above the backplate, and a light incident surface of the light guide plate is disposed to face towards the light source.

As compared to the prior art, the present disclosure has the aluminum extruded piece formed as a part of the backplate of the backlight module and has the light source integrated onto the aluminum extruded piece directly. In this way, heat generated by the light source can be transmitted through the aluminum extruded piece directly to the atmosphere to result in a reduced contact heat resistance, thus improving the heat dissipation efficiency. Furthermore, because the main heat dissipating surface at the light emitting side of the backplate is designed as an aluminum extruded piece while other parts of the backplate are formed of a plastic baseplate that delivers a moderate heat dissipating effect but is cheap in price, the material cost of the backplate is lowered.

### BRIEF DESCRIPTION OF THE DRAWINGS

The components in the drawings are not necessarily drawn to scale, the emphasis instead being placed upon clearly illustrating the principles of at least one embodiment of the present disclosure. In the drawings, like reference numerals designate corresponding parts throughout various views, and all the views are schematic.

FIG. 1 is a schematic structural view of an LCD device and a backlight module thereof in a prior art.

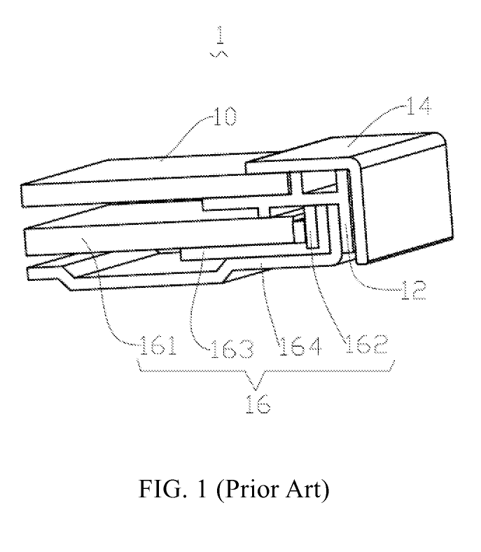

FIG. 2 is a schematic structural view of a preferred embodiment of an LCD device according to the present disclosure.

FIG. 3 is a schematic structural view of a first embodiment of a backlight module according to the present disclosure.

FIG. 4 is a schematic view of a second embodiment of the backlight module according to the present disclosure.

FIG. 5 is a schematic perspective structural view of an enclosure of the display device assembled with the backlight module shown in FIG. 4.

FIG. 6 is a schematic structural view of a third embodiment of the backlight module according to the present disclosure.

FIG. 7 is a schematic structural view of a fourth embodiment of the backlight module according to the present disclosure.

### DETAILED DESCRIPTION OF THE INVENTION

The present disclosure is more particularly described in the following examples that are intended as illustrative only since numerous modifications and variations therein will be apparent to those skilled in the art.

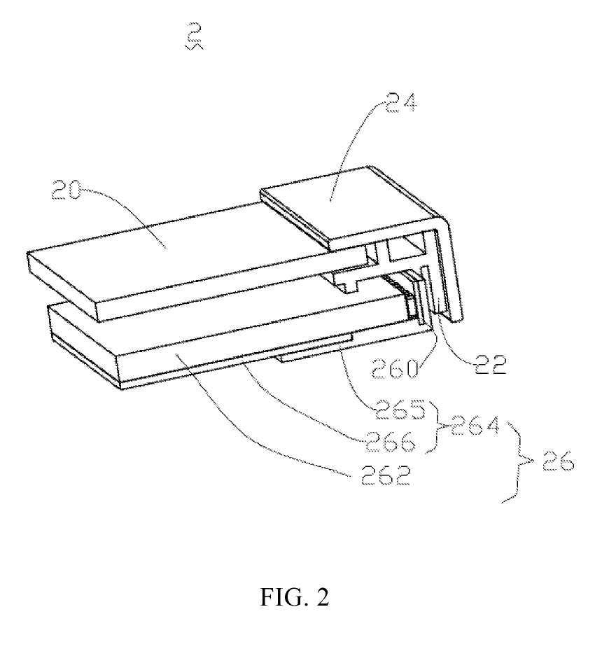

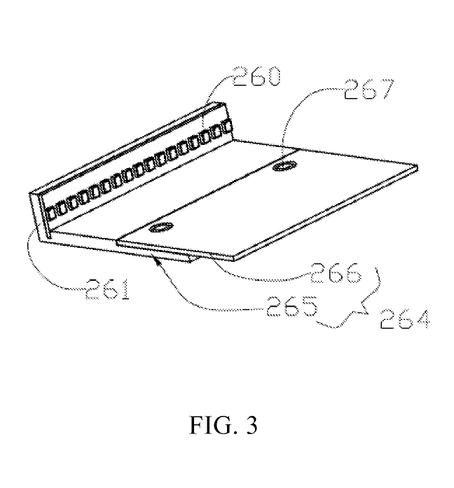

Referring to FIGS. 2 and 3, FIG. 2 is a schematic structural view of a preferred embodiment of an LCD device 2 according to the present disclosure, and FIG. 3 is a schematic structural view of a first embodiment of a backlight module according to the present disclosure. The LCD device 2 comprises a display panel 20, a plastic part 22, a front frame 24 and a backlight module 26. The display panel 20 is disposed above the backlight module 26, and the front frame 24 and the plastic part 22 cooperate with each other to fix the display panel 20 and the backlight module 26.

The backlight module 26 comprises a light source 260, a light guide plate 262 and a backplate 264. The light guide plate 262 is disposed above the backplate 264 with a light incident surface thereof facing towards the light source 260.

The backplate 264 comprises an aluminum extruded piece 265 and a plastic baseplate 266, and the light source 260 is disposed on a sidewall 261 of the aluminum extruded piece 265 that is located at a side away from the plastic baseplate 266. In this embodiment, the light source 260 is soldered to the sidewall 261 of the aluminum extruded piece 265.

The plastic baseplate 266 is fixedly connected to a side of the aluminum extruded piece 265. Specifically, both the aluminum extruded piece 265 and the plastic baseplate 266 are formed with a plurality of fixing holes 267, and the aluminum extruded piece 265 is fixedly connected to the plastic baseplate 266 by screws (not shown) inserted through the plurality of fixing holes 267. Additionally, the plastic baseplate 266 may also be replaced by other materials that delivers a moderate heat dissipating effect but is cheap in price.

Because the light source 260 is directly disposed on the sidewall 261 of the aluminum extruded piece 265 that is located at the side away from the plastic baseplate 266, the portion of the backplate corresponding to the light source 266 is the aluminum extruded piece 265, heat generated by the light source 260 can be dissipated to the atmosphere through the aluminum extruded piece 265 directly. Thereby, the contact resistance between the light source 260 and the aluminum extruded piece 265 is reduced to improve heat dissipation efficiency of the backlight module 26. Furthermore, except the main heat dissipating surface that is made of extruded aluminum, other portions of the backplate 264 are formed of the plastic baseplate 266 which delivers a moderate heat dissipating effect but is cheap in price, so usage of the costly extruded aluminum is reduced and, consequently, the material cost is lowered.

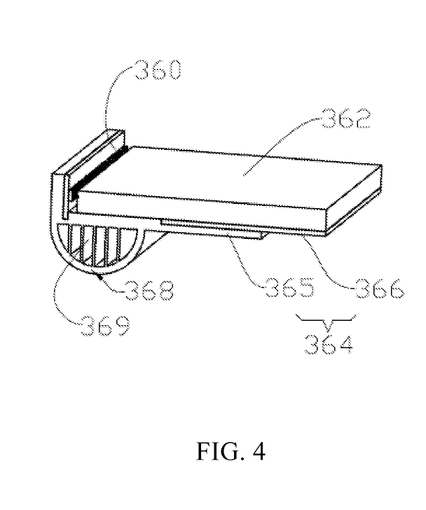

Referring to FIG. 4, there is shown a schematic view of a second embodiment of the backlight module according to the present disclosure. The backlight module comprises a light source 360, a light guide plate 362 and a backplate 364. The backplate 364 comprises an aluminum extruded piece 365 and a plastic baseplate 366. The second embodiment of the backlight module differs from the first embodiment in that, in this embodiment, a hollow portion 368 is further disposed on a bottom surface of the aluminum extruded piece 365 that is located at a side away from the plastic baseplate 366. The hollow portion 368 has a plurality of heat dissipating fins 369 and opens to the outside at both ends for purpose of heat convection.

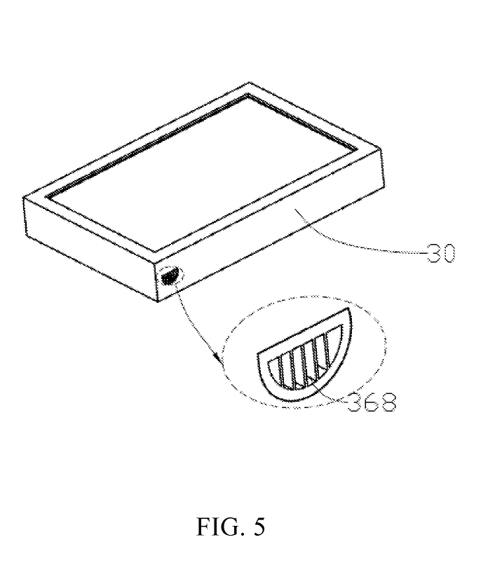

FIG. 5 is a schematic perspective structural view of an enclosure of the display device assembled with the backlight module shown in FIG. 4. The display device comprises an enclosure 30 and a backlight module (not shown) disposed inside the enclosure 30. The enclosure 30 is formed with a through-hole (not shown) at a location corresponding to the hollow portion 368. Because both ends of the hollow portion 368 of the backlight module open to the outside, an independent heat convection system can be formed between the ends of the enclosure 30 after the hollow portion 368 is assembled to the enclosure 30, and this can further improve the heat dissipation efficiency of the backlight module.

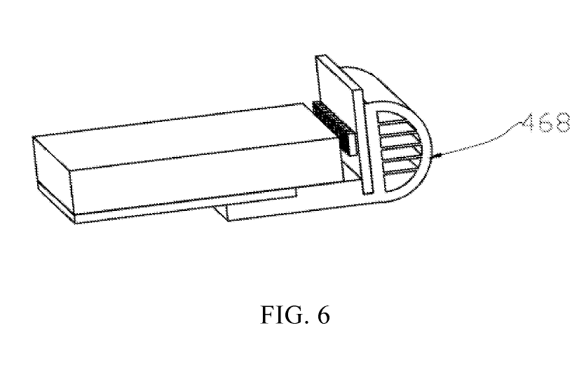

Referring next to FIG. 6, there is shown a schematic view of a third embodiment of the backlight module according to the present disclosure. This embodiment differs from the second embodiment shown in FIG. 4 mainly in the position where the hollow portion is disposed. Specifically, in this embodiment, the hollow portion 468 is disposed on an outer surface of the sidewall where the light source is disposed and is opposite to the light source. Of course, the hollow portion 468 may also be disposed at other locations near the light source as appropriate.

Although the aforesaid embodiments are all described with a backlight module of the single-side emission type as an example, the present disclosure is not merely limited thereto.

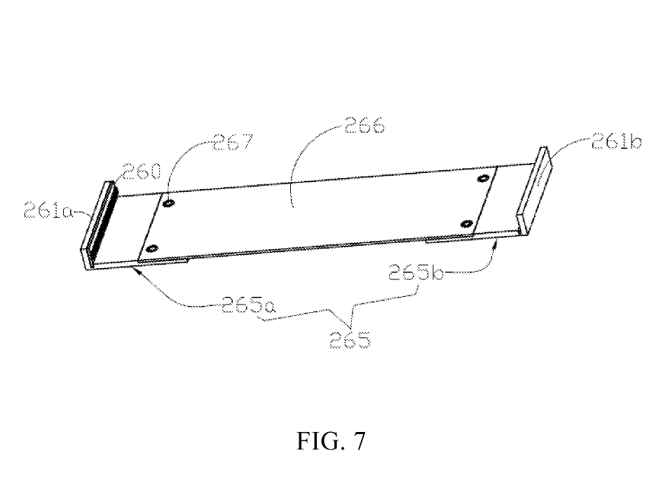

Referring to FIG. 7, there is shown a schematic structural view of a fourth embodiment of the backlight module according to the present disclosure. This embodiment differs from the first embodiment shown in FIG. 3 mainly in that, the backlight module is of a dual-side emission type. In this embodiment, the aluminum extruded piece 265 comprises a first aluminum extruded piece 265a and a second aluminum extruded piece 265b, and light sources 260 are soldered on a sidewall 261a of the first aluminum extruded piece 265a and a sidewall 261b of the second aluminum extruded piece 265b respectively. The plastic baseplate 266 is disposed between the first aluminum extruded piece 265a and the second aluminum extruded piece 265b, and is fixedly connected to a side of the first aluminum extruded piece 265a and a side of the second aluminum extruded piece 265b that are away from the light sources 260 respectively by screws (not shown) inserted through the fixing holes 267.

In the dual-side emission mode, hollow portions may further be disposed below or behind the light sources 260 on the aluminum extruded piece 265 to further improve the heat dissipation efficiency.

According to the above descriptions, the display device and the backlight module of the present disclosure have the aluminum extruded piece(s) formed as a part of the backplate of the backlight module and have the light source(s) integrated onto the aluminum extruded piece(s) directly. In this way, heat generated by the light source(s) can be transmitted through the aluminum extruded piece(s) directly to the atmosphere to reduce contact heat resistance, thus improving the heat dissipation efficiency. Furthermore, through the heat dissipating design of the hollow portion, an independent heat convection system can be formed after the backlight module is assembled to the display device enclosure, which further improves the heat dissipation efficiency of the backlight module. Moreover, because the main heat dissipating area of the backplate is designed as an aluminum extruded piece(s) while other parts of the backplate are formed of a plastic baseplate that delivers a moderate heat dissipating effect but is cheap in price, the material cost of the backplate is lowered.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A backlight module, comprising:
a light source; and
a backplate;
wherein the backplate comprises an aluminum extruded piece and a plastic baseplate, the plastic baseplate is fixedly connected to a side of the aluminum extruded piece, the aluminum extruded piece is provided with a hollow portion at a side away from the plastic baseplate, and the light source is disposed on a sidewall of the aluminum extruded piece that is located at the side away from the plastic baseplate.

2. The backlight module of claim 1, wherein the hollow portion comprises heat-dissipating fins, and both ends of the hollow portion open to the outside.

3. A backlight module, comprising:
a light source; and
a backplate;
wherein the backplate comprises an aluminum extruded piece and a plastic baseplate, the plastic baseplate is fixedly connected to a side of the aluminum extruded piece, and the light source is disposed on a sidewall of the aluminum extruded piece that is located at a side away from the plastic baseplate.

4. The backlight module of claim 3, wherein the light source is soldered to the sidewall of the aluminum extruded piece.

5. The backlight module of claim 3, wherein the aluminum extruded piece comprises a first aluminum extruded piece and a second aluminum extruded piece, and the plastic baseplate is disposed between the first aluminum extruded piece and the second aluminum extruded piece.

6. The backlight module of claim 3, wherein both the aluminum extruded piece and the plastic baseplate are formed with a plurality of fixing holes, and the aluminum extruded piece is fixedly connected to the plastic baseplate by screws inserted through the plurality of fixing holes.

7. The backlight module of claim 3, wherein the aluminum extruded piece is provided with a hollow portion at a side away from the plastic baseplate.

8. The backlight module of claim 7, wherein the hollow portion comprises heat-dissipating fins, and both ends of the hollow portion open to the outside.

9. The backlight module of claim 8, wherein the hollow portion is disposed on a bottom surface of the aluminum extruded piece that is located at the side away from the plastic baseplate.

10. The backlight module of claim 8, wherein the hollow portion is disposed on an outer surface of the sidewall opposite to the light source.

11. The backlight module of claim 3, further comprising a light guide plate located above the backplate, and a light incident surface of the light guide plate is disposed to face towards the light source.

12. A display device comprising a backlight module, the backlight module comprising:
a light source; and
a backplate;
wherein the backplate comprises an aluminum extruded piece and a plastic baseplate, the plastic baseplate is fixedly connected to a side of the aluminum extruded piece, and the light source is disposed on a sidewall of the aluminum extruded piece that is located at a side away from the plastic baseplate.

13. The display device of claim 12, wherein the light source is soldered to the sidewall of the aluminum extruded piece.

14. The display device of claim 12, wherein the aluminum extruded piece comprises a first aluminum extruded piece and a second aluminum extruded piece, and the plastic baseplate is disposed between the first aluminum extruded piece and the second aluminum extruded piece.

15. The display device of claim 12, wherein both the aluminum extruded piece and the plastic baseplate are formed with a plurality of fixing holes, and the aluminum extruded piece is fixedly connected to the plastic baseplate by screws inserted through the plurality of fixing holes.

16. The display device of claim 12, wherein the aluminum extruded piece is provided with a hollow portion at a side away from the plastic baseplate.

17. The display device of claim 16, wherein the hollow portion comprises heat-dissipating fins, and both ends of the hollow portion open to the outside.

18. The display device of claim 17, wherein the hollow portion is disposed on a bottom surface of the aluminum extruded piece that is located at the side away from the plastic baseplate.

19. The display device of claim 17, wherein the hollow portion is disposed on an outer surface of the sidewall opposite to the light source.

20. The display device of claim 12, wherein the backlight module further comprises a light guide plate located above the backplate, and a light incident surface of the light guide plate is disposed to face towards the light source.
